(19) United States
(12) Patent Application Publication
(10) Pub. No.: US 2026/0281355 A1
(43) Pub. Date: Sep. 17, 2026

(54) Methods and Apparatus of Adaptive Quantization Parameters in Video Coding

(71) Applicant: MEDIATEK INC., Hsinchu City (TW)

(72) Inventors: Yi-Wen CHEN, San Jose, CA (US); Tzu-Der CHUANG, Hsinchu City (TW); Ching-Yeh CHEN, Hsinchu City (TW); Chih-Wei HSU, Hsinchu City (TW)

(21) Appl. No.: 19/472,647

(22) PCT Filed: Apr. 28, 2024
(86) PCT No.: PCT/CN2024/090313

§ 371 Date: Oct. 4, 2025

Related U.S. Application Data
(60) Provisional application No. 63/500,302, filed on May 5, 2023.

(51) Int. Cl. H04N 19/124; H04N 19/12; H04N 19/167; H04N 19/172; H04N 19/174; H04N 19/176; H04N 19/177; H04N 19/182; H04N 19/60; H04N 19/70

(52) U.S. Cl. CPC H04N 19/124; H04N 19/12; H04N 19/167; H04N 19/172; H04N 19/174; H04N 19/176; H04N 19/177; H04N 19/182; H04N 19/60; H04N 19/70

(57) ABSTRACT

A method and apparatus for video coding using adaptive quantization are disclosed. According to one method, a picture-level QP (Quantization Parameter) for the current picture is determined. One or more propagation regions in the current picture are determined, wherein said one or more propagation regions have no corresponding reference region in one or more reference pictures of the current picture. A QP offset is determined to modify the picture-level QP. Transform blocks in said one or more propagation regions are encoded or decoded according to the modified QP. In another method, the QP offset is derived according to the complexity of the transform coefficients/residuals of the current block. In yet another method, context modelling related to transform coefficients/residuals based on complexity of transform coefficients/residuals is disclosed.

### CROSS REFERENCE TO RELATED APPLICATIONS

The present invention is a non-Provisional Application of and claims priority to U.S. Provisional Patent Application No. 63/500,302, filed on May 5, 2023. The U.S. Provisional Patent Application is hereby incorporated by reference in its entirety.

### FIELD OF THE INVENTION

The present invention relates to quantization and/or context modelling of transform coefficients in a video coding system. In particular, the present invention relates to adaptive quantization of transform coefficients and/or context modelling related to transform coefficients based on complexity of transform coefficients, or adaptive quantization by adjusting an original quantization parameter for propagation regions in a video coding system.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

### Partitioning of the CTUs Using a Tree Structure

In HEVC, a CTU is split into CUs by using a quaternary-tree (QT) structure denoted as coding tree to adapt to various local characteristics. The decision whether to code a picture area using inter-picture (temporal) or intra-picture (spatial) prediction is made at the leaf CU level. Each leaf CU can be further split into one, two or four Pus according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU . . .

FIG. 3 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64:64 and the maximum supported chroma transform size is 32×32. When the width or height of the CB is larger the maximum transform width or height, the CB is automatically split in the horizontal and/or vertical direction to meet the transform size restriction in that direction.

In VVC, the coding tree scheme supports the ability for the luma and chroma to have separate block tree structures. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional candidates introduced in VVC. The merge mode can be applied to any inter-predicted CU, not only for skip mode. The alternative to merge mode is the explicit transmission of motion parameters, where motion vector, corresponding reference picture index for each reference picture list, reference picture list usage flag and other needed information are signalled explicitly per each CU.

ITU-T VCEG (Q6/16) and ISO/IEC MPEG (JTC 1/SC 29/WG 5) are studying the potential need for standardization of future video coding technology with a compression capability significantly exceeding that of the current VVC standard. The Enhanced Compression Model (ECM) reference software is provided to demonstrate a reference implementation of encoding techniques and the decoding process for JVET enhanced compression beyond VVC capability exploration work. The reference software can be accessed via https://vcgit.hhi.fraunhofer.de/ecm/ECM.git. ECM basically is the successor to VVC and thus it shares many common parts as VVC.

### Transform, Scaling and Quantization in HEVC

HEVC, like its predecessors, employs transform coding on the prediction residual. The residual block is divided into multiple square transform blocks (TBs), which can be of varying sizes ranging from 4×4 to 32×32.

To calculate two-dimensional transforms, 1-D transforms are performed separately in both the horizontal and vertical directions. The core transform matrices are designed by approximating scaled DCT (Discrete Cosine Transform) basis functions while taking into account the factors such as reducing the required dynamic range for transform computation and optimizing the accuracy and orthogonality of the matrix entries when represented as integer values.

HEVC employs a quantization scheme known as Uniform Reconstruction Quantization (URQ), which is similar to the one used in H.264/MPEG-4 AVC, and is governed by a quantization parameter (QP). The QP values range from 0 to 51, and each increment of 6 results in doubling of the quantization step size, thus providing a roughly logarithmic mapping of QP values to step sizes. Additionally, HEVC supports quantization scaling matrices.

An increment of 1 in the quantization parameter results in a step size increase of roughly 12% (i.e., 2^{1/6}). Meanwhile, an increase of 6 results in doubling of the step size. The resulting relationship between and the equivalent quantization step size for an orthonormal transform is now given by:

$${Q}_{step} ( QP ) = {( {2}^{1 / 6} )}^{QP - 4} ,$$

which can also be expressed in the following equation:

$${Q}_{step} ( QP ) = {G}_{QP \%6} << ( QP / 6 ) ,$$

where G=[G₀, G₁ . . . G₅]=[2^{-1/6}, 2^{-3/6}, 2^{-2/6}, 2^{-1/6}, 2⁰, 2¹].

Qₛₜₑₚ is then used in the encoding process for scaling of transform coefficient C to get the coefficient levels L:

$$L = C / {Q}_{step} .$$

At the decoder, Qₛₜₑₚ is used in the decoding process for scaling of transform coefficient level (L) to get the coefficient C:

$$C = L * {Q}_{step} .$$

### Transform, Scaling and Quantization in VVC

The fundamental idea of utilizing an integer transform to the prediction residual and then quantizing the resulting coefficients has been established in previous standards and is still utilized in VVC. However, VVC goes further by implementing extended transforms, refined quantization, and residual coding to achieve superior energy compaction of the prediction residual. VVC utilizes more advanced designs on transforms and quantization to achieve better coding performance.

### Larger and Non-Square Transform

VVC not only utilizes separable square transforms with kernel sizes ranging from 4×4 to 32×32, but VVC also offers support for non-square transforms by combining various kernel sizes that increase dyadically from length-2 to length-64 both horizontally and vertically.

### Multiple Transform Set (MTS)

Sometimes, alternative transforms can be more effective at de-correlating the prediction residual, particularly in the case of the intra prediction residual where the prediction error tends to increase as the distance from the boundary samples increases. In HEVC, this is addressed by incorporating an additional 4×4 integer approximation of the DST type-VII for intra prediction luma residuals. VVC takes this a step further by introducing four additional horizontal/vertical combinations of separate DST type-VII and DCT type-VIII integer kernels for all square and non-square luma block sizes ranging from 4×4 to 32×32. The selection of which transform to use is either explicitly signalled per CU or implicitly derived based on the width and height of the transform block. Similar to the DCT type-II based transform of length 64, the non-DCT type-II coefficients outside a 16×16 area are zeroed out to reduce the implementation complexity of the additional transforms.

### Low Frequency Non-Separable Transform (LENST)

The encoder has the ability to apply a set of non-separable mode-dependent transforms to the low frequency coefficients of the DCT type-II based primary transform in intra-coded blocks. These additional inverse transform kernels were derived from training data to take advantage of the remaining directionality characteristics present in the intra-picture prediction residual signals.

### Subblock Transform (SBT) Mode

When coding inter-predicted CUs, a sub-partition of the residual block is selected to be coded while the remaining portion is skipped. This coded residual sub-partition can be either half or one-quarter the size of the CU, with an MTS transform type for the coded residual being implicitly inferred. The left, right, top, or bottom part of the coded half or quarter sub-partition can be selected, resulting in a total of 8 modes that need to be signalled per CU

### Extended Quantization Control

VVC maintains the same uniform reconstruction quantizer design as HEVC, which utilizes a quantization parameter (QP) to control the size of the quantizer step. However, in order to achieve lower bit rates, VVC supports a larger maximum QP value than HEVC. While the maximum QP value in HEVC is 51, VVC can support QP values up to 63, resulting in a maximum inverse quantization scaling step size that is four times larger. Similar to HEVC, the QP can be adjusted locally for rate control and perceptual optimization. To facilitate this, VVC retains the concept of quantization groups for signalling a luma QP offset and scaling lists for frequency-dependent inverse quantization scaling from HEVC, which has been adapted to support non-square block structures. The only difference from HEVC is a constant offset of 6*(b-8) which depends on the bit depth b of the decoded video samples.

### Dependent Quantization (DQ):

The encoder enables the switching between two scalar inverse quantizers for decoding each transform coefficient based on the value of the previous quantized coefficient. This technique, despite using a scalar inverse quantizer at the decoder, can be considered a type of vector quantization as it jointly encodes the transform coefficients in an interdependent manner, utilizing a trellis-based search at the encoder. Additionally, VVC retains the sign data hiding (SDH) approach introduced in HEVC as a lower-complexity alternative to DQ, which is another dependent coding trick.

In addition, the same HEVC scalar quantization is used with a new concept called dependent scalar quantization. Dependent scalar quantization refers to an approach in which the set of admissible reconstruction values for a transform coefficient depends on the values of the transform coefficient levels that precede the current transform coefficient level in the reconstruction order. The main effect of this approach is that, in comparison to conventional independent scalar quantization as used in HEVC, the admissible reconstruction vectors are packed denser in the N-dimensional vector space (N represents the number of transform coefficients in a transform block). That means, for a given average number of admissible reconstruction vectors per N-dimensional unit volume, the average distortion between an input vector and the closest reconstruction vector is reduced. The approach of dependent scalar quantization is realized by: (a) defining two scalar quantizers with different reconstruction levels and (b) defining a process for switching between the two scalar quantizers.

The two scalar quantizers used, denoted by Q0 and Q1, are illustrated in FIG. 4. The locations of the available reconstruction levels are uniquely specified by a quantization step size A. The scalar quantizer used (Q0 or Q1) is not explicitly signalled in the bitstream. Instead, the quantizer used for a current transform coefficient is determined by the parities of the transform coefficient levels that precede the current transform coefficient in coding/reconstruction order.

As illustrated in FIG. 5, the switching between the two scalar quantizers (Q0 and Q1) is realized via a state machine with four states. The state can take four different values: 0, 1, 2, 3. It is uniquely determined by the parities of the transform coefficient levels preceding the current transform coefficient in coding/reconstruction order. At the start of the inverse quantization for a transform block, the state is set equal to 0. The transform coefficients are reconstructed in scanning order (i.e., in the same order they are entropy decoded). After a current transform coefficient is reconstructed, the state is updated as shown in FIG. 5, where k denotes the value of the transform coefficient level.

In FIG. 5, the upper two states, i.e., states 0 and 1, are associated with quantizer Q0 and the lower two states, i.e., states 2 and 3, are associated with quantizer Q1. The operation initially starts with state 0 and Q0 is used to quantize a current coefficient value. If the resulting quantization index has an even parity (i.e., k& 1=0), the next state is still state 0 as indicated by transition 510 and quantizer Q0 is used for the next coefficient. If the resulting quantization index has an odd parity (i.e., k&: 1=1), the next state is state 2 as indicated by transition $12 and quantizer Q1 is used for the next coefficient. For state 2, if the resulting quantization index (Q1 used) has an even parity (i.e., k&1=0), the next state is state 1 as indicated by transition 520 and quantizer Q0 is used for the next coefficient. For state 2, if the resulting quantization index (Q1 used) has an odd parity (i.e., k&1=1), the next state is state 5 as indicated by transition 522 and quantizer Q1 is used for the next coefficient. The state transition for state 1 and state 5 can be determined similarly as shown in FIG. 5. A transition table associated with FIG. 5 is shown in Table 1.

TABLE 1
State Transition Table Corresponding to FIG. 5.

| | |
|---|---|
| Current | Next state for |

| state | (k&1) == 0 | (k&1) == 1 |
|---|---|---|
| 0 | 0 | 2 |
| 1 | 2 | 0 |
| 2 | 1 | 3 |
| 3 | 3 | 1 |

### Joint Coding of Chroma Residuals (JCCR):

VVC can efficiently take advantage of the remaining correlations present in the quantized chroma residual signal through the use of a JCCR mode. This mode signals only one residual block, which is then utilized to derive residual blocks for both chroma components.

### Transform, Scaling and Quantization in ECM

I. Dependent Quantization with 8-States

The coding efficiency of trellis-coded quantization in VVC can be increases by increasing the number of quantization states (at the cost of a higher encoder complexity). Dependent quantization with 8 quantization states in addition to the current variant of dependent quantization with 4 quantization state is supported (JVET-Q0243, Heiko Schwarz, et al., “Additional support of dependent quantization with 8 states”, Joint Video Exploration Team (JVET) of ITU-T SG 16 WP 3 and ISO/IEC JTC 1/SC 29/WG 11, 17th Meeting: Brussels, BE, 7-17 Jan. 2020, Document: JVET-Q0243).

For supporting both variants of dependent quantization (4 and 8 states) in a unified framework, the decoding process for the VVC variant of dependent quantization is re-written.

The state transition table (sec. 7.4.12.11 in VVC) is modified from

$$QStateTransTable [ ] [ ] = \{ \{ 0 , 2 \} , \{ 2 , 0 \} , \{ 1 , 3 \} , \{ 3 , 1 \} \} ,$$

to

$$QStateTransTable [ ] [ ] = \{ \{ 0 , 1 \} , \{ 2 , 3 \} , \{ 1 , 0 \} , \{ 3 , 2 \} \} .$$

There are three aspects that depend on the quantization state QState: (a) the mapping of transmitted transform coefficient levels to intermediate quantization indexes (part of the dequantization specified in the syntax); (b) the context selection for the sig_coeff_flag: (c) the derivation of the mapping parameter ZeroPos[ ] for transform coefficient levels coded in bypass mode. All three aspects are re-written in order to reflect the swapping of quantization states:
(a) The mapping of transmitted transform coefficient levels to intermediate quantization indexes (see syntax structure residual_coding( ) in VVC) is modified from:

$$TransCoeffLevel [ x 0 ] [ y 0 ] [ cIdx ] [ xC ] [ yC ] = ( 2 * Abs Level [ xC ] [ yC ] - ( QState > 1 ? 1 : 0 ) ) * ( 1 - 2 * coeff\_sign \_flag [ n ] )$$

to

$$TransCoeffLevel [ x 0 ] [ y 0 ] [ cldx ] [ xC ] [ yC ] = ( 2 ⋆ Abs Level [ xC ] [ yC ] - ( QState \& 1 ) ) * ( 1 - 2 ⋆ coeff\_sign \_flag [ n ] )$$

(b) The context selection of the sig_coeff_flag (see Sec. 9.3.4.2.8 in VVC) depends on a parameter (context set id) that is derived based on the quantization state. In VVC, this parameter is given by:

$$Max ( 0 , QState - 1 ) .$$

With the relabeling of the quantization states, this parameter can be derived according to:

$$ctxSetId [ QState \& 3 ] with ctxSetId [ ] = \{ 0 , 1 , 0 , 2 \} .$$

It should be noted that for the 4-state version, the result of (QState & 3) is equal to QState. The masking is only required for the &-state version of dependent quantization.
(c) The derivation of the mapping parameter ZeroPos[ ] for transform coefficient levels coded in bypass mode is modified from

$$ZeroPos [ n ] = ( QState < 2 ? 1 : 2 ) << cRiceParam$$

to

$$ZeroPos [ n ] = ( 1 + ( QState \& 1 ) ) << cRiceParam$$

### II. Maximum Transform Size and Zeroing-Out of Transform Coefficients

Both CTU size and maximum transform size (i.e., all MTS transform kernels) are extended to 256, where the maximum intra coded block can have a size of 128×128. The maximum CTU size is set to 256 for UHD (Ultra High Definition) sequences and it is set to 128, otherwise. In the primary transformation process, there is no nonnative zeroing out operation applied on transform coefficients. However, if LFNST is applied, the primary transform coefficients outside the LFNST region are normatively zeroed-out.

### III. Enhanced MTS for Intra Coding

In the current VVC design, for MTS, only DST7 and DCT8 transform kernels are utilized, which are used for intra and inter coding.

Additional primary transforms including DCT5, DST4, DST1, and identity transform (IDT) are employed. Also MTS set is determined depending on the TU size and intra mode information. 16 different TU sizes are considered, for each TU size, 5 different classes are considered depending on intra-mode information. For each class, 1, 4 or 6 different transform pairs are considered. Number of intra MTS candidates are adaptively selected (between 1, 4 and 6 MTS candidates) depending on the sum of absolute value of transform coefficients. The sum is compared against two fixed thresholds to determine the total number of allowed MTS candidates:
1 candidate: sum<=th0,
4 candidates: th0<sum<=th1,
6 candidates: sum>th1.

Note, although a total of 80 different classes are considered, some of those different classes often share exactly the same transform set. Therefore, there are 58 (less than 80) unique entries in the resultant LUT.

For angular modes, a joint symmetry over TU shape and intra prediction is considered. Therefore, a mode i (i>34) with TU shape A×B will be mapped to the same class corresponding to the mode j=(68-i) with TU shape B×A. However, for each transform pair, the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between −2 and −14. Similarly, mode 66 is used for mode 67 to mode 80.

### IV. Inter MTS Optimization

For the MTS of inter-coded CUs, four candidates: {(DST7, DST7), (DST7, DCT8), (DCT8, DST7), (DCT8, DCT8)} are used for every CU. For the larger resolution sequences (i.e., width>1080) maximum CU size for Inter-MTS usage is set to 32 (i.e., Inter-MTS is used for CU with width<=32 and height<=32), and for the remaining sequences (i.e., smaller resolution) it is set to 16. For 4-pt, 8-pt and 16-pt transforms, the current AMT transform cores, i.e., DST-7 and DCT-8, is replaced with separable KLTs, as proposed in JVET-J0021 (Y. Chen, et al., “Description of SDR, HDR and 360° video coding technology proposal by Qualcomm and Technicolor-low and high complexity versions”, Joint Video Exploration Team (JVET) of ITU-T SG 16 WP 3 and ISO/IEC JTC I/SC 29/WG 11, 10th Meeting: San Diego, US, 10-20 Apr. 2018, Document: JVET-J0021).

V. Secondary Transformation: LFNST Extension with Large Kernel

The LFNST design in VVC is extended as follows:
The number of LFNST sets(S) and candidates (C) are extended to S=35 and C=3, and the LFNST set (IfnstTrSetIdx) for a given intra mode (predModeIntra) is derived according to the following formula:
   For predModeIntra<2, IfnstTrSetIdx is equal to 2
   IfastTrSetIdx=predModeIntra, for predModeIntra in [0,34]
   IfnstTrSetIdx=68-predModeIntra, for predModeIntra in [35,66]
Three different kernels, LFNST4, LFNST8, and LFNST16, are defined to indicate LFNST kernel sets, which are applied to 4×N/N×4 (N≥4), 8×N/N×8 (N≥8), and M×N (M, N≥16), respectively.

The kernel dimensions are specified by:

$$( LFSNT 4 , LFNST {8}^{*} , LRST {16}^{*} ) = ( 16 \times 16 , 32 \times 64 , 32 \times 96 )$$

The forward LFNST is applied to top-left low frequency region, which is called Region-Of-Interest (ROI). When LFNST is applied, primary-transformed coefficients that exist in the region other than ROI are zeroed out, which is not changed from the VVC standard.

The ROI for LFNST16 is depicted in FIG. 6. It consists of six 4×4 sub-blocks (as shown in grey squares in FIG. 6), which are consecutive in scan order. Since the number of input samples is 96, transform matrix for forward LFNST16 can be Rx96. R is chosen to be 32 in this contribution, 32 coefficients (two 4×4 sub-blocks) are generated from forward LFNST16 accordingly, which are placed following coefficient scan order.

The ROI for LFNST8 (as shown in grey squares in FIG. 7) is shown in FIG. 7. The forward LFNST8 matrix can be Rx64 and R is chosen to be 32. The generated coefficients are located in the same manner as with LFNST16.

The mapping from intra prediction modes to these sets is shown in Table 2.

TABLE 2
Mapping of intra prediction modes to LFNST set index

| | Intra pred. mode | | | | | | | | | | | | | | | |
|---|---|---|---|---|---|---|---|---|---|---|---|---|---|---|---|---|
| | −14 | −13 | −12 | −11 | −10 | −9 | −8 | −7 | −6 | −5 | −4 | −3 | −2 | −1 | 0 | 1 |
| LFNST set index | 2 | 2 | 2 | 2 | 2 | 2 | 2 | 2 | 2 | 2 | 2 | 2 | 2 | 2 | 0 | 1 |

| | Intra pred. mode | | | | | | | | | | | | | | | |
|---|---|---|---|---|---|---|---|---|---|---|---|---|---|---|---|---|
| | 2 | 3 | 4 | 5 | 6 | 7 | 8 | 9 | 10 | 11 | 12 | 13 | 14 | 15 | 16 | 17 |
| LFNST set index | 2 | 3 | 4 | 5 | 6 | 7 | 8 | 9 | 10 | 11 | 12 | 13 | 14 | 15 | 16 | 17 |
| | Intra pred. mode | | | | | | | | | | | | | | | |
| | 18 | 19 | 20 | 21 | 22 | 23 | 24 | 25 | 26 | 27 | 28 | 29 | 30 | 31 | 32 | 33 |
| LFNST set index | 18 | 19 | 20 | 21 | 22 | 23 | 24 | 25 | 26 | 27 | 28 | 29 | 30 | 31 | 32 | 33 |
| | Intra pred. mode | | | | | | | | | | | | | | | |
| | 34 | 35 | 36 | 37 | 38 | 39 | 40 | 41 | 42 | 43 | 44 | 45 | 46 | 47 | 48 | 49 |
| LFNST set index | 34 | 33 | 32 | 31 | 30 | 29 | 28 | 27 | 26 | 25 | 24 | 23 | 22 | 21 | 20 | 19 |
| | Intra pred. mode | | | | | | | | | | | | | | | |
| | 50 | 51 | 52 | 53 | 54 | 55 | 56 | 57 | 58 | 59 | 60 | 61 | 62 | 63 | 64 | 65 |
| LFNST set index | 18 | 17 | 16 | 15 | 14 | 13 | 12 | 11 | 10 | 9 | 8 | 7 | 6 | 5 | 4 | 3 |

| | Intra pred. mode | | | | | | | | | | | | | | |
|---|---|---|---|---|---|---|---|---|---|---|---|---|---|---|---|
| | 66 | 67 | 68 | 69 | 70 | 71 | 72 | 73 | 74 | 75 | 76 | 77 | 78 | 79 | 80 |
| LFNST set index | 2 | 2 | 2 | 2 | 2 | 2 | 2 | 2 | 2 | 2 | 2 | 2 | 2 | 2 | 2 |

For blocks using MIP (Matrix Intra Prediction) prediction, the LFNST set index is derived as follows. DIMD 810 (Decoder side Intra Mode Derivation) is used to derive the intra prediction mode of the current block based on the MIP predicted samples before upsampling. Specifically, a horizontal gradient and a vertical gradient are calculated for each predicted sample to build a HoG 820 (Histogram of Gradient), as shown in FIG. 8. Then the intra prediction mode with the largest histogram amplitude values is used to determine the LFNST transform set and LFNST Transpose flag. In FIG. 8, matrix vector multiplication module 830 is used to generate MIP prediction 840; and further processed by MIP prediction upsampling module 850 to generate the upsampled output 860.

Quantization is performed using integer arithmetic in HEVC, with quantizer step size doubling for every increase of QP by 6. The QP remainder (QP % 6) specifies a fractional scaling of the quantizer step size normalized at 16384 (corresponding to 2^{QUANT_SHIFT}, with QUANT_SHIFT equal to 14) and using a table f[x]. When scaling lists are used, an additional fractional scaling is performed that depends on the position of the transform coefficient in the TB, with either a default scaling list used, or a scaling list supplied via a file. The additional fractional scaling is normalized at 16. Section 4.5.4 of HEVC describes scaling list derivation for different sized TBs and prediction modes.

When scaling lists are not used, the quantized transform coefficients qᵢⱼ (i, j=0..nS-1) are derived from the transform coefficients dᵢⱼ (1, j=0..nS-1) and the scaling list sᵢⱼ (i, i=0..nS-1) as:

$${q}_{ij} = ( {d}_{ij} ⋆ ( f [ QP \% 6 ] + offset ) >> ( QUANT\_SHIFT + MAX\_TR \_DYNAMIC \_RANGE + QP / 6 − {log}_{2} ( nS ) - BitDepth ) , with i , j = 0 , … , nS - 1$$

where

$$f [ x ] = \{ 26214 , 23302 , 20560 , 18396 , 16384 , 14564 \} , x = 0 , … , 5 ,$$

$${2}^{28 + QP / δ \text{-} uS - BitDepth} < offset < {2}^{29 + QP / δ \text{-} nS - BitDepth} = QUANT\_SHIFT = 14 \text{,}$$

MAX TR DYNAMIC RANGE=15 when extended_precision_processing_flag is equal to 0, otherwise see Section 4.5.8.

When scaling lists are used, the quantized transform coefficients qᵢⱼ (i, j=0..nS-1) are derived from the transform coefficients dᵢⱼ (i, j=0..nS-1) and the scaling list sᵢⱼ (i, j=0..nS-1) as:

$${q}_{ij} = ( {d}_{ij} ⋆ ( f [ QP \% 6 ] << 4 / {s}_{ij} ) + offset ) >> ( QUANT\_SHIFT + MAX\_TR \_DYNAMIC \_RANGE + QP / 6 − {log}_{2} ( nS ) - BitDepth ) , with i , j = 0 , … , nS - 1$$

The value offset is set at 171/512 for I slices and 85/512 for P or B slices.

When scaling lists are not applied, sᵢⱼ=16 for all i and j.

A rate-distortion optimized quantization (RDOQ) process is also available and may be used instead, as described in Section 6.6.2 of HEVC.

### VI. Shifting Quantization Centre in JVET-AD0251

Recently, it was shown that end-to-end compression models are an unconstrained multi objective optimization problem where the solution should meet Karush-Kubn-Tucker (KKT) conditions as disclosed in a VQ and Shifting literature by Balcilar, M., et al. (Balcilar, M., Damodaran, B. B., Naser, K., Galpin, F., & Hellier, P. Vector Quantization and Shifting: Exploiting Latent Properties to Optimize Neural Codecs. Available online at: https://openreview.net/forum?id=QVSoh6VM4nG). According to KKT conditions, the sum of gradient with respect to each objective should be zero. Since there are two objectives (rate and distortion), the gradient with respect to distortion and the gradient with respect to rate should cancel themselves out (i.e., they show opposite directions). Thus, one can be used instead of the other by simply changing direction. It was shown that shifting the latents (the transform coefficient) by the gradient with respect to rate (available on the decoder side) as it is negative of gradient with respect to distortion (unavailable in decoder side) can allow 1-2% bd-rate gain on end-to-end compression models. In JVET-AD0251, the transform coefficient is shifted by using the gradient of very simple rate prediction in order to decrease the quantization error.

An idea is proposed in JVET-AD0251 (Muhammet Balcilar, et al., “AHG12 Shifting Quantizer Center”, Joint Video Exploration Team (JVET) of ITU-T SG 16 WP 3 and ISO/IEC JTC I/SC 29/WG 11, 30th Meeting, Antalya, TR, 21-28 Apr. 2023, Document: JVET-AD0251) to add some offset value which is derived by gradient of the entropy on the reconstructed transform coefficients.

In JVET-AD0251, it is assumed that the RDO based quantization such as Dependent Quantization (DQ) with Trellis Coded Quantization procedure (TCQ) is an unconstrained multi objective optimization problem that can be generalized by Eq. (1).

$${y}^{⋆} = arg {min}_{y} [ R ( y ) + λ D ( x , {Q}^{- 1} ( y ) ) ] \qquad ( 1 )$$

In this equation, x∈Rⁿ is the n length real numbered coefficient to be quantized, y∈Zⁿ is the quantization indices defined on discrete set of reconstruction points. Using any quantizer Q(·) and dequantizer function Q⁻¹(·), the indices and reconstruction can be obtained by y=Q(x) and \hat{x}=Q⁻¹ (y) respectively. Here, function R(·) is the rate function of the indices and function D(.,.) is a distortion metric such as Mean Square Error (MSE).

Using KKT conditions on Eq. (1), it can be shown that if the solution found by RDO based quantization is optimal, the following condition should be met.

$${∇}_{y} ( R ( y ) ) = - λ {∇}_{y} ( D ( x , {Q}^{- 1} ( y ) ) ) . \qquad ( 2 )$$

Of the first order gradient-based optimization methods, if the current solution takes a step to the negative direction of its gradient w.r.t some objective function, this objective function gets smaller. For RDO based quantization case, if the quantization indices y are shifted by gradient w.r.t distortion such as y←y−ρ∇_{y}(D(x,Q⁻¹(y))), where ρ∈R⁺ is step size, the distortion D(x, Q⁻¹(y)) gets smaller. However, it is not possible to know distortion without knowing original input data explicitly. But using Eq. (2), we use its negative gradient w.r.t rate as it is its gradient w.r.t distortion. Thus, our proposal is to shift the quantization indices in the loop of encoder's dequantization and decoder's dequantization by Eq.3 as follows.

$$y ← y + ρ {∇}_{y} ( R ( y ) ) . \qquad ( 3 )$$

Eq. (3) tells us to add some offset value to the quantization indices (y) (or dequantized coefficient Q⁻¹(y)) which increases the rate. But since this added offset is during the dequantized stage, it has no effect on the rate but increases reconstruction quality in theory.

In this proposal, we assume very simple proxy of rate prediction where each quantization indices are independent, and rate increases by absolute value of the coefficient as in Eq. (4)

$$R ( {y}_{i} ) ≅ a \vert {y}_{i} \vert + b \qquad ( 4 )$$

Since gradient of rate in Eq. (4) is 0, where yᵢ=0; a where yᵢ>0; and −a where yᵢ<0, the offset is applied as in Eq. (5).

$$\{ \begin{matrix}{y}_{i} ← {y}_{i} + {ρ}^{*} & {y}_{i} > 0 \\ {y}_{i} ← {y}_{i} - {ρ}^{⋆} & {y}_{i} < 0 \\ {y}_{i} ← {y}_{i} & {y}_{i} = 0\end{matrix} , for i = 1 … n \qquad ( 5 )$$

As shown in Eq. (5), it can be seen as it applies an offset to the quantization index that makes them far away from zero point. The amount of the offset ρ*∈R⁺ can be fine-tuned over a validation set and used as a universal value for all videos.

In practice, since quantization indices should be integer, the original reconstructed coefficient is first calculated by Q⁻¹(yᵢ)) and reconstructed value when the quantization indices is shifted 1 quantization index to the opposite direction to the zero centre as Q⁻¹(yᵢ)) where y′ᵢ=yᵢ+(yᵢ>0? 1:−1). Then we take the weighted sum of Q⁻¹(yᵢ)) and Q⁻¹(y′ᵢ)) as the reconstructed coefficient in Eq. (6).

$$\hat{x} = ( 982 ⋆ {Q}^{− 1} ( {y}_{i} ) + 42 ⋆ {Q}^{− 1} ( {y}_{i}^{′} ) ) ≫ 10 \qquad ( 6 )$$

Note that this shifting on reconstruction coefficient is done only if the quantization index is not zero.

In the present invention, methods and apparatus to adaptive quantization and/or context modelling or binarization of transform coefficients based on complexity of the transform coefficients, or adaptive quantization by adjusting an original quantization parameter for propagation regions in the picture.

### BRIEF SUMMARY OF THE INVENTION

A method and apparatus for video coding using adaptive quantization are disclosed. According to this method, input data related to a current picture/slice are received, wherein the input data correspond to pixel data to be encoded at a video encoder side or the input data correspond to a coded data to be decoded at a video decoder side. A picture/slice-level QP (Quantization Parameter) for the current picture/slice is determined. One or more propagation regions in the current picture/slice are determined, wherein said one or more propagation regions have no corresponding reference region in one or more reference pictures/slices of the current picture/slice. A QP offset is determined, wherein a modified QP is derived based on the picture/slice-level QP and the QP offset. Transform blocks in said one or more propagation regions are encoded or decoded according to the modified QP.

In one embodiment, the modified QP is smaller than the picture/slice-level QP. In one embodiment, one or more syntax elements are signalled in a bitstream or parsed from the bitstream to indicate said one or more propagation regions. In one embodiment, location of a target propagation region is identified by a starting position, width and/or height of the target propagation region. In one embodiment, multiple regions are defined for the current picture/slice and a set of indexes are assigned to the multiple regions, and wherein a target propagation region is identified by a target index from the set of indexes.

In one embodiment, said determining said one or more propagation regions, said determining the QP offset, and said encoding or decoding the transform blocks in said one or more propagation regions according to the modified QP are selectively applied to one or more target coding pictures/slices. In one embodiment, said one or more target coding pictures/slices correspond to a key picture of a GOP (Group Of Pictures) prediction structure, and wherein POCs (Picture Order Counts) of all reference pictures are less than POC (Picture Order Count) of the key picture.

According to another method, input data related to a current block in a current picture are received, wherein the input data correspond to transform coefficients of the current block at an encoder side and the input data correspond to a quantized transform coefficients of the current block at a decoder side. A QP (Quantization Parameter) offset is determined, wherein the QP offset is related to complexity of the transform coefficients of the current block. A modified QP for the current block is determined based on an original QP for the current block and the QP offset. A quantization process is applied to the current block at the encoder side or an inverse quantization process is applied to the current block at the decoder side by using the modified QP.

In one embodiment, the QP offset is derived depending on the complexity of the transform coefficients of the current block at the encoder side or the QP offset is parsed at the decoder side. In one embodiment, if the complexity of the transform coefficients of the current block is higher, the modified QP for the current block is higher than the original QP. In one embodiment, the QP offset is signalled in a bitstream or parsed from the bitstream. In another embodiment, the QP offset is signalled or parsed in sequence level, picture level, slice level, block level, or a combination thereof. In yet another embodiment, the QP offset is predefined at both the encoder side and the decoder side without signalling into a bitstream.

In one embodiment, the QP offset is applied to part of frequency band or part of coefficient band of the current block. In one embodiment, the complexity of the transform coefficients of the current block is measured based on absolute values of all the transform coefficients of the current block of a number of absolute values of transform coefficients larger than or equal to a threshold. In another embodiment, the complexity of the transform coefficients of the current block is determined based on coding mode, block size, colour component, whether belonging to a group of pre-defined modes, or last significant coefficient position of the current block.

In one embodiment, the complexity of the transform coefficients of the current block is measured based on a sum of non-zero coefficients or count of the non-zero coefficients of the current block. In one embodiment, if the complexity of the transform coefficients of the current block is high, the transform coefficients of the current block are shifted by using gradient of rate prediction.

According to yet another method, input data related to a current block in a current picture are received, wherein the input data correspond to transform coefficients/residuals of the current block at an encoder side and the input data correspond to a quantized transform coefficients/residuals of the current block at a decoder side. Complexity of the transform coefficients/residuals of the current block is determined. Context modelling or binarization of coefficient coding for the current block is determined depending on the complexity of the transform coefficients/residuals of the current block. The current block is encoded or decoded according to the context modelling or the binarization of coefficient/residual coding.

In one embodiment, the context modelling comprises target context modelling of significant coefficient flag or one or more syntaxes related to determining whether one or more coefficients are non-zero or not. In another embodiment, the context modelling or the binarization of coefficient/residual coding comprises target context modelling or target binarization of last significant coefficient position. In yet another embodiment, the context modelling or the binarization of coefficient/coding comprises target context modelling or target binarization of one or more coefficient levels. In one embodiment, the context modelling or the binarization of coefficient/residual coding for a first block having high complexity of the transform coefficients/residuals of the first block is different from the context modelling or the binarization of coefficient/residual coding for a second block having low complexity of the transform coefficients/residuals of the second block.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of multi-type tree splitting modes.

FIG. 3 illustrates an example of quadtree with nested multi-type tree coding block structure.

FIG. 4 illustrates an example of Trellis-Coded-Quantization (TCQ) with two scalar quantizers, denoted by Q0 and Q1, and the locations of the available reconstruction levels are uniquely specified by a quantization step size 4.

FIG. 5 illustrates an example of the finite state machine corresponding to the trellis structure with 4 states used in dependent scalar quantization, where the 4 states (i.e., states 0, 1, 2 and 3 enclosed in circles) and the transition among the states are shown.

FIG. 6 illustrates an example of ROI (Region-Of-Interest) for LFNST16.

FIG. 7 illustrates an example of ROI (Region-Of-Interest) for LFNST8.

FIG. 8 illustrates an example of LFNST modification for MIP coded blocks, which utilizes DIMD to derive the LFNST transform set and determine LFNST transpose flag.

FIG. 9 illustrates an example of picture-level QP setting for a hierarchical GOP8 prediction structure.

FIG. 10A illustrates an example of a video sequence using a hierarchical GOPS prediction structure, where the contents correspond to scene of still objects with camera panning.

FIG. 10B illustrates an example of propagation region identified in the video sequence according to an embodiment of the present invention.

FIG. 11 illustrates an example of pre-define propagation regions corresponding to left, above, right and bottom regions of the picture.

FIG. 12 illustrates a flowchart of an exemplary video coding system that uses a QP offset to modify the picture-level QP for propagation regions in the picture according to an embodiment of the present invention.

FIG. 13 illustrates a flowchart of an exemplary video coding system that determines a QP offset based on the complexity of transform coefficients of a current block to modify the picture-level QP according to an embodiment of the present invention.

FIG. 14 illustrates a flowchart of an exemplary video coding system, where context modelling or binarization of coefficient coding for the current block depends on the complexity of the transform coefficients of the current block according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve the performance of adaptive quantization, adaptive quantization of transform coefficients and/or context modelling related to transform coefficients based on complexity of transform coefficients, or adaptive quantization by adjusting an original quantization parameter for propagation regions in a video coding system are disclosed.

When coding the current picture as an inter picture, its reference picture is usually coded using a quantization parameter (QP) lower than the QP used by the current picture. Since the reference picture is coded using a lower QP, it's reconstructed pixels have higher reconstruction quality (e.g. higher PSNR or lower mean squared errors (MSE). The higher quality of the reconstructed pixels can then be propagated to the picture which refers to it as a reference picture. As illustrated in FIG. 9, a group of 8 pictures (GOP8) prediction structure is utilized, the first picture with picture order count (POC) being equal to 0 is first coded as an intra picture with QP 22. The picture with POC 8 is than coded as a Bi-predictive inter picture with QP 24 and refers to the picture with POC 0 910 as its reference picture. Then, the picture with POC 4 920 is coded as bi-predictive picture using QP 25 and refers to both the picture with POC 0 and the picture with POC 8 930. As explained, to enable the reconstruction pixels propagate to the picture that refers to it. The QPs of the reference pictures are normally set lower than the pictures that refer to them. It is noted that, the concept can also be extended to the block level.

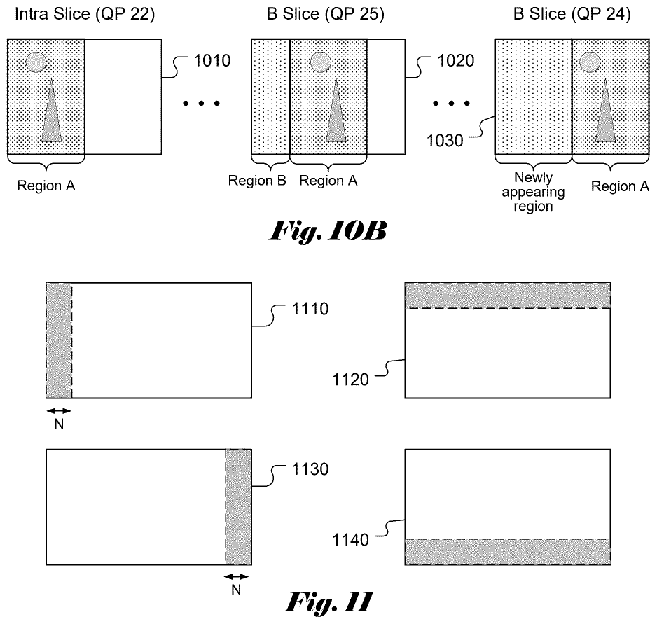

In one example of a video sequence which captures a static scene of a triangle and a round object with the camera panning from the right to the left as illustrated in FIG. 10A, where POC 0 (1010), . . . , POC 4 (1020), . . . . POC 8 (1030). In FIG. 10B. the region A of the picture of POC 4 1020 can refer to both the region A of the picture of POC 0 1010 and region A in the picture with POC 8 1030. However, the region B in the picture of POC 4 1020 has no corresponding region in the picture of POC 0 1010 and only can find a corresponding region in the picture of POC 8 1030. To facilitate the propagation effect of the reference picture, it is proposed to use lower QPs for the coding of the blocks within the newly appearing regions in one picture (e.g. the picture with POC 8 1030 in FIG. 10B). The newly appearing regions can be one or multiple regions within the picture that has no corresponding pixels in its reference picture (e.g. the intra picture with POC 0 1010 in FIG. 10B). In the present invention, the newly appearing region can also be termed as the propagation region.

In the first embodiment of this invention, a mechanism is proposed to indicate which one or multiple regions are assigned a QP offset for coding the blocks within each region to boost the efficiency of the propagating effect. In the proposed scheme, the QP offset is added to the original QP assigned for coding the blocks within the propagation regions. The QP offset can be either positive or negative. However, to increase the quality (e.g. PSNR) of the reconstructed pixels in the propagated region, the QP offset should be negative, which means a smaller QP is used for the coding of the blocks within the propagated region. The propagation regions can be specified by signalling additional syntax elements in the bitstream to indicate the region's starting position (e.g. the position of the top-left/top-right/bottom-left/bottom-right pixel of the region) and the width and/or height of the region.

In yet another example, multiple regions are defined, and each region is assigned an index. The encoder can signal syntax elements in the bitstream to indicate which index is used as the propagation region. Specifically, the propagation region is defined as a region with width W and height H, and the position of the top-left sample of this region is X and Y, respectively. As shown in the FIG. 11, an example 1110 with a left region which aligned with the left border can be defined as W=N, H=picture height, X=0 and Y=0. An example 1120 with an above region aligned with the above border can be defined as W=picture width, H=N, X=0 and Y=0. An example 1130 with a right region aligned with the right border can be defined as W=N, H=picture height, X=picture width −N and Y=0. An example 1140 with a bottom region aligned with the above border can be defined as W=picture width, H=N, X=0 and Y=picture height −N. N can be any integer; N can be implicitly defined for the encoder and decoder. In another embodiment, N can also be signalled in the bitstream at sequence level, picture level or slice level. The indexes 0, 1,2 and 3 are then assigned to the left region, above region, right region and the bottom region, respectively.

The proposed scheme of the propagation regions can be selectively applied to some of the coding pictures. For example, the propagation regions are only utilized in the key picture of a GOP prediction structure. The key picture is the picture where all reference pictures' POC being less than the POC of the key picture.

Moreover, when the residual signal is complex, its transform coefficients normally contain more high frequency components. For example, the residual of an intra mode coded block is usually more complex than the residual of an inter mode coded block. It is observed that allocating bits for coding one complex residual block shows worse rate-distortion trade-off than allocating bits for coding one less-complex residual block.

In the second embodiment of this invention, an QP offset is added to the original QP for coding of the transform block. The QP offset for one transform block is determined based on the complexity of the transform coefficients. In the present invention, the residual of a transform skip coded block can also be regarded as one special type of transform coefficients. The complexity of the transform coefficients can be measured using the different approaches as illustrated below. When the complexity is regarded as high, a positive value or a negative value is used as the QP offset. The derived QP offset can be signalled into the bitstream at different levels such as sequence level (e.g. video parameter set and sequence parameter set), picture level (e.g. picture parameter set and picture header), slice level (e.g. slice header) and/or block level (e.g. CTU, CU, PU, TU, CTB, CB. PB, TB). In another scheme, the QP offset can be pre-defined for both encoder and decoder without being signalled into the bitstream. For example, 1 is used as the QP offset for the high-complexity coefficient block, while 0 is used as the QP offset for other blocks which are determined to be non-high-complexity coefficients.

In yet another scheme, when the complexity is regarded as low, a negative value or a positive value is used as the QP offset and is added to the original QP for the coding of the transform block.

In yet another embodiment, the QP offset can be applied to part of the frequency band (for transformed TB) or part of the coefficient band (for transform skip TB) for high (or low) complexity coefficient block. For example, the QP offset can be applied to high frequency band or the coefficient with scan position larger than a threshold or x/y position larger than a threshold for high (or low) complexity coefficient block

Various approaches to measure the complexity of the transform coefficients are illustrated below:

Complexity measurement approach #1:

The sum of the absolute values of all the transform coefficients is accumulated. If the sum is larger than a threshold, the coefficients are regarded as high complexity. Otherwise, the coefficients are regarded as lower complexity.

Complexity measurement approach #2:

Count the number the absolute values of all the transform coefficients which are larger than or equal to a threshold. If the count is larger than a threshold, the coefficients are regarded as high complexity. Otherwise, the coefficients are regarded as lower complexity. The threshold value can be a positive integer or 0.

Complexity measurement approach #3:

All the TBs associated with a PU/CU coded as intra mode are regarded as having high complexity coefficients. Otherwise, the coefficients are regarded as lower complexity.

Complexity measurement approach #4:

All the TBs associated with a PU have size being smaller than or equal to a threshold is regarded as having high complexity coefficients. Otherwise, the coefficients are regarded as lower complexity.

Complexity measurement approach #5:

All the TBs associated with a luma component are regarded as high complexity coefficients. Otherwise, all the TBs associated with a chroma component are regarded as lower complexity.

Complexity measurement approach #6:

All the TBs associated with a PU/CU coded as some pre-determined modes are regarded as having high complexity coefficients. Otherwise, the coefficients are regarded as lower complexity. In one example, the pre-determined modes can include one or more intra prediction mode (e.g. DC/Planar, or angular mode), IBC, intraTMP, multi-reference-line mode, spatial GPM, TIMD, or DIMD mode.

Complexity measurement approach #7:

The last significant coefficient position of the TB can be used to determine whether the block is complex or not. If the last significant coefficient position is larger than a threshold, the coefficients are regarded as high complexity. Otherwise, the coefficients are regarded as lower complexity. The position can be scan order, or position x/y of the TB. The threshold for position x and y can be different.

Complexity measurement approach #8:

The sum of non-zero coefficients of the TB or the count of the non-zero coefficients of the TB, where the positions of the non-zero coefficients satisfy some conditions, can be used to determine whether the block is complex or not. In one example, if the sum/counts of non-zero coefficients with position larger than threshold1 is larger than threshold2, the coefficients are regarded as high complex. Otherwise (i.e., the sum/counts of non-zero coefficients with position larger than threshold1 is smaller than or equal to threshold2), the coefficients are regarded as low complex. The position can be scan order, or position x/y of the TB. The threshold for position x and y can be different.

In yet another embodiment, the context modelling or binarization of coefficient coding can be different for high complexity/low complexity coefficient blocks. In one example, the context modelling of significant coefficient flag or the syntaxes that determine whether the coefficient is non-zero or not can be different for high complexity/low complexity coefficient blocks. In another example, the context modelling or binarization of last significant coefficient position can be different for high complexity/low complexity coefficient blocks. In another example, the context modelling or binarization of coefficient level can be different for high complexity/low complexity coefficient blocks.

In yet another embodiment, the default quantization matrix can be different for high complexity/low complexity coefficient blocks.

The proposed schemes can also be extended to classifying the transform coefficients into more than two complexity levels. For example, the transform coefficients can have 4 complexity levels and different QP offsets can be assigned to the coefficient blocks with different complexity levels. The sum of the absolute values of all the transform coefficients is accumulated. If the sum is larger than a threshold TH1, the coefficients are regarded as highest complexity. If the sum is smaller than TH1, but larger than a threshold TH2, the coefficients are regarded as second highest complexity. If the sum is smaller than TH2, but larger than a threshold TH3, the coefficients are regarded as third highest complexity. Otherwise, the coefficients are regarded as lowest complexity. Here TH1>TH2>Th3.

In the third embodiment of this invention, when the complexity is regarded as high, the shifting quantization centre in JVET-AD0251 is performed. Otherwise, no quantization centre shifting is performed. The complexity measurement approaches illustrated in the second embodiment can also be used for this invented method.

In another embodiment, the complexity of one TB can be decided according to the neighbouring reconstructed samples, such as the variance of neighbouring reconstructed samples at top and/or left boundary. In another embodiment, besides neighbouring reconstructed samples, the extended predictors from the current CU or the predictor of the current CU are also utilized to evaluate the complexity. For example, the result of template matching or boundary matching are considered.

Any of the foregoing proposed adaptive quantization methods can be applied independently or jointly. Moreover, any of the foregoing proposed methods can be implemented in encoders and/or decoders. For example, any of the proposed adaptive quantization methods can be implemented in the quantization module associated with intra and/or inter prediction module of an encoder and/or a decoder. Alternatively, any of the proposed methods can be implemented as a circuit coupled to inter prediction module of the encoder and/or the decoder.

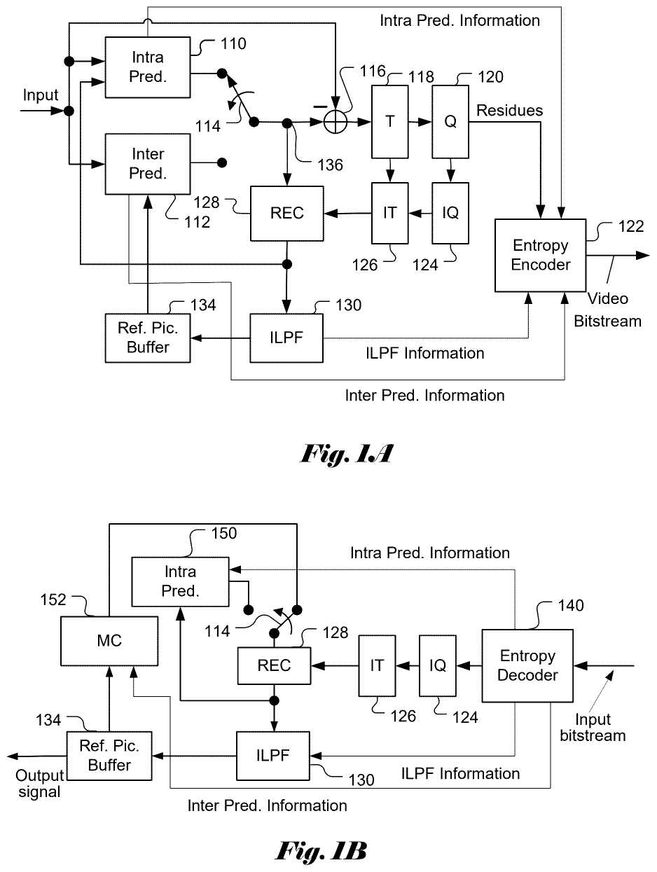

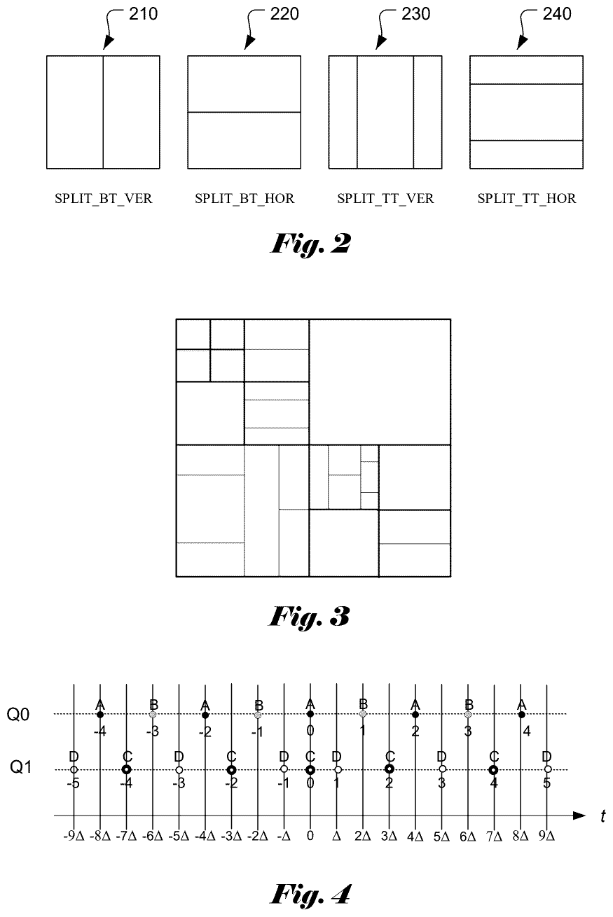

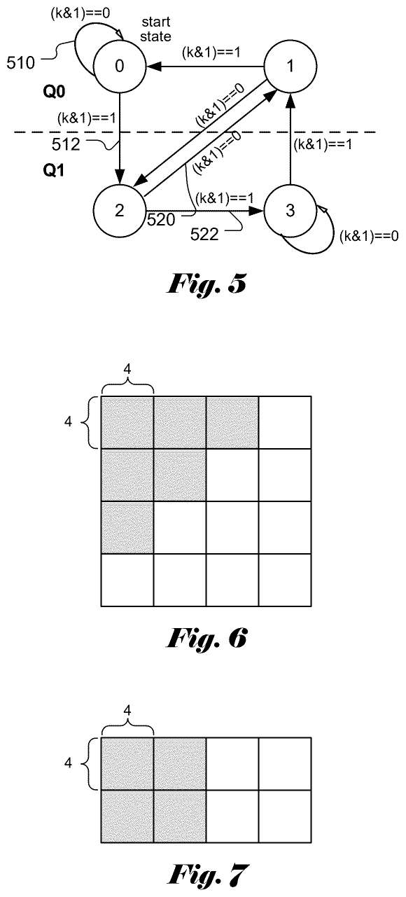

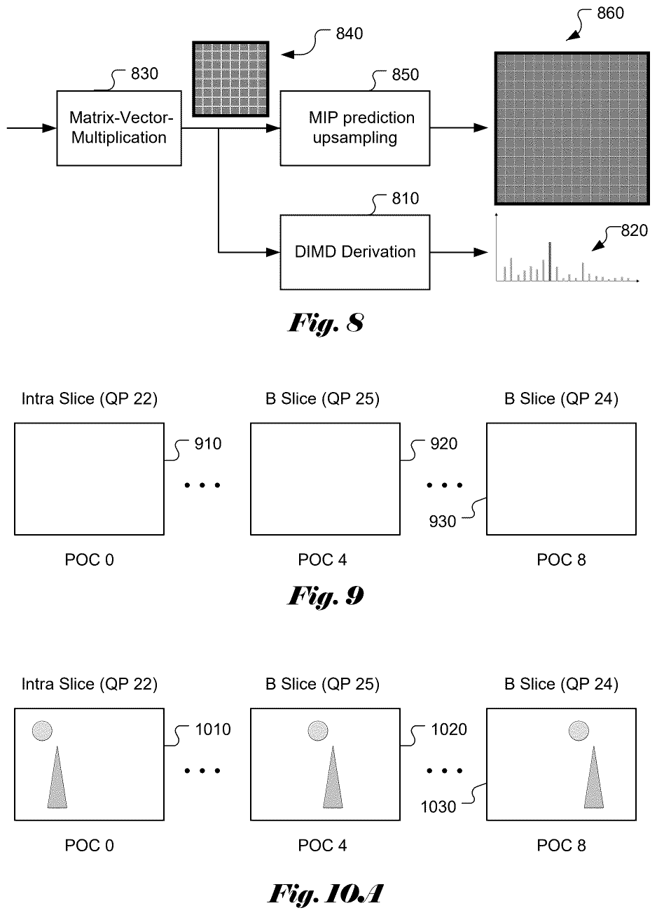

The adaptive quantization methods as described above can be implemented in an encoder side or a decoder side. For example, any of the proposed adaptive quantization methods can be implemented in a de-quantization module (e.g. IQ 124 in FIG. 1B), entropy decoder (e.g. Entropy Decoder 140 in FIG. 1B), and/or an Intra/Inter coding module (e.g. Intra Pred. 150/MC 152 in FIG. 1B) in a decoder, or a quantization module (e.g. IQ 120 in FIG. 1A), entropy encoder (e.g. Entropy Encoder 124 in FIG. 1A), and/or an Intra/Inter coding module is an encoder (e.g. Intra Pred. 110/Inter Pred. 112 in FIG. 1A). Any of the proposed adaptive quantization methods can also be implemented as circuits coupled to the intra/inter coding module at the decoder or the encoder. However, the decoder or encoder may also use additional processing unit to implement the required cross-component prediction processing. The required processing for the present invention may be implemented according to executable software or firmware codes stored on a media, such as hard disk or flash memory, for a CPU (Central Processing Unit) or programmable devices (e.g. DSP (Digital Signal Processor) or FPGA (Field Programmable Gate Array)).

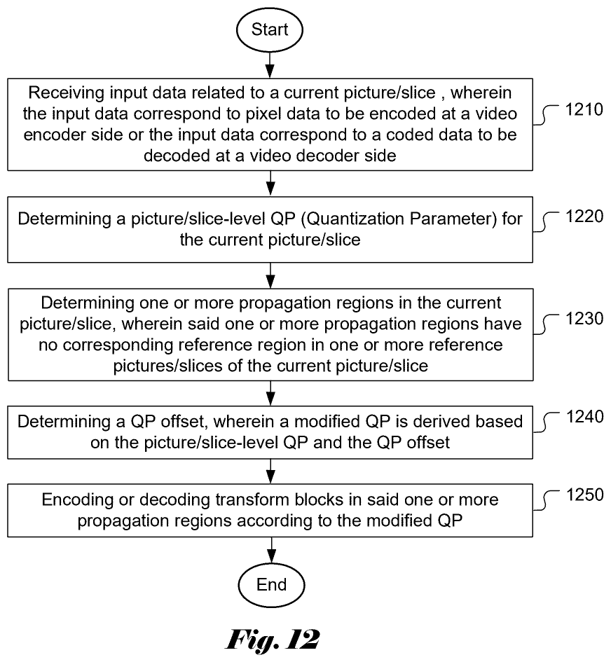

FIG. 12 illustrates a flowchart of an exemplary video coding system that uses a QP offset to modify the picture-level QP for propagation regions in the picture according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data related to a current picture/slice are received in step 1210, wherein the input data correspond to pixel data to be encoded at a video encoder side or the input data correspond to a coded data to be decoded at a video decoder side. A picture/slice-level QP (Quantization Parameter) for the current picture is determined in step 1220. One or more propagation regions in the current picture/slice are determined in step 1230, wherein said one or more propagation regions have no corresponding reference region in one or more reference pictures/slices of the current picture/slice. A QP offset is determined in step 1240, wherein a modified QP is derived based on the picture/slice-level QP and the QP offset. Transform blocks in said one or more propagation regions are encoded or decoded according to the modified QP in step 1250.

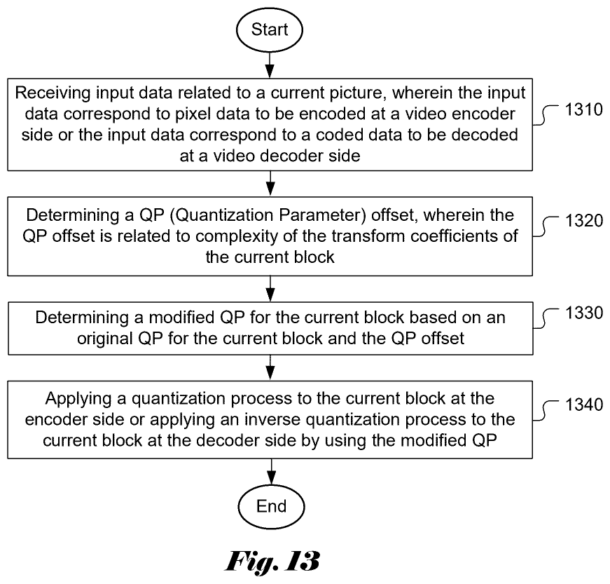

FIG. 13 illustrates a flowchart of an exemplary video coding system that determines a QP offset based on the complexity of transform coefficients of a current block to modify the picture-level QP according to an embodiment of the present invention. According to this method, input data related to a current block in a current picture are received in step 1310, wherein the input data correspond to transform coefficients of the current block at an encoder side and the input data correspond to a quantized transform coefficients of the current block at a decoder side. A QP (Quantization Parameter) offset is determined in step 1320, wherein the QP offset is related to complexity of the transform coefficients of the current block. A modified QP for the current block is determined based on an original QP for the current block and the QP offset in step 1330. A quantization process is applied to the current block at the encoder side or an inverse quantization process is applied to the current block at the decoder side by using the modified QP in step 1340.

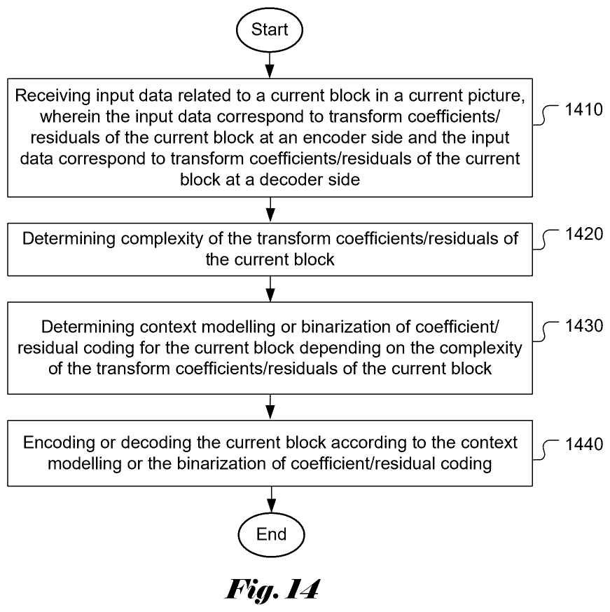

FIG. 14 illustrates a flowchart of an exemplary video coding system, where context modelling or binarization of coefficient/residual coding for the current block depends on the complexity of the transform coefficients/residuals of the current block according to an embodiment of the present invention. According to this method, input data related to a current block in a current picture are received in step 1410, wherein the input data correspond to transform coefficients/residuals of the current block at an encoder side and the input data correspond to a quantized transform coefficients/residuals of the current block at a decoder side. Complexity of the transform coefficients/residuals of the current block is determined in step 1420. Context modelling or binarization of coefficient/residual coding for the current block is determined in step 1430depending on the complexity of the transform coefficients/residuals of the current block. The current block is encoded or decoded according to the context modelling or the binarization of coefficient/residual coding in step 1440.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data related to a current picture/slice, wherein the input data correspond to pixel data to be encoded at a video encoder side or the input data correspond to a coded data to be decoded at a video decoder side;
determining a picture/slice-level QP (Quantization Parameter) for the current picture/slice;
determining one or more propagation regions in the current picture/slice, wherein said one or more propagation regions have no corresponding reference region in one or more reference pictures/slices of the current picture/slice;
determining a QP offset, wherein a modified QP is derived based on the picture/slice-level QP and the QP offset; and
encoding or decoding transform blocks in said one or more propagation regions according to the modified QP.

2. The method of claim 1, wherein the modified QP is smaller than the picture/slice-level QP.

3. The method of claim 1, wherein one or more syntax elements are signalled in a bitstream or parsed from the bitstream to indicate said one or more propagation regions.

4. The method of claim 3, wherein location of a target propagation region is identified by a starting position, width and/or height of the target propagation region.

5. The method of claim 3, wherein multiple regions are defined for the current picture/slice and a set of indexes are assigned to the multiple regions, and wherein a target propagation region is identified by a target index from the set of indexes.

6. The method of claim 1, wherein said determining said one or more propagation regions, said determining the QP offset, and said encoding or decoding the transform blocks in said one or more propagation regions according to the modified QP are selectively applied to one or more target coding pictures.

7. The method of claim 6, wherein said one or more target coding pictures correspond to a key picture of a GOP (Group Of Pictures) prediction structure, and wherein POCs (Picture Order Counts) of all reference pictures are less than POC (Picture Order Count) of the key picture.

8. An apparatus of video coding, the apparatus comprising one or more electronic circuits or processors arranged to:
receive input data related to a current picture/slice, wherein the input data correspond to pixel data to be encoded at a video encoder side or the input data correspond to a coded data to be decoded at a video decoder side;
determine a picture/slice-level QP (Quantization Parameter) for the current picture/slice;
determine one or more propagation regions in the current picture/slice, wherein said one or more propagation regions have no corresponding reference region in one or more reference pictures/slices of the current picture/slice;
determine a QP offset, wherein a modified QP is derived based on the picture/slice-level QP and the QP offset; and
encode or decode transform blocks in said one or more propagation regions according to the modified QP.

9. A method of video coding, the method comprising:
receiving input data related to a current block in a current picture, wherein the input data correspond to transform coefficients of the current block at an encoder side and the input data correspond to a quantized transform coefficients of the current block at a decoder side;
determining a QP (Quantization Parameter) offset, wherein the QP offset is related to complexity of the transform coefficients of the current block;
determining a modified QP for the current block based on an original QP for the current block and the QP offset; and
applying a quantization process to the current block at the encoder side or applying an inverse quantization process to the current block at the decoder side by using the modified QP.

10. The method of claim 9, wherein the QP offset is derived depending on the complexity of the transform coefficients of the current picture.

11. The method of claim 9, wherein if the complexity of the transform coefficients of the current block is higher, the modified QP for the current block is higher than the original QP.

12. The method of claim 9, wherein the QP offset is signalled in a bitstream or parsed from the bitstream.

13. The method of claim 9, wherein the QP offset is signalled or parsed in sequence level, picture level, slice level, block level, or a combination thereof.

14. The method of claim 9, wherein the QP offset is predefined at both the encoder side and the decoder side without signalling into a bitstream.

15. The method of claim 9, wherein the QP offset is applied to part of frequency band or part of coefficient band of the current block.

16. The method of claim 9, wherein the complexity of the transform coefficients of the current block is measured based on absolute values of all the transform coefficients of the current block or a number of absolute values of transform coefficients larger than or equal to a threshold.

17. The method of claim 9, wherein the complexity of the transform coefficients of the current block is determined based on coding mode, block size, colour component, whether belonging to a group of pre-defined modes, or last significant coefficient position of the current block.

18. The method of claim 9, wherein the complexity of the transform coefficients of the current block is measured based on a sum of non-zero coefficients or count of the non-zero coefficients of the current block.

19. The method of claim 9, wherein if the complexity of the transform coefficients of the current block is high, the transform coefficients of the current block are shifted by using gradient of rate prediction.

20. An apparatus of video coding, the apparatus comprising one or more electronic circuits or processors arranged to:
receive input data related to a current block in a current picture, wherein the input data correspond to transform coefficients of the current block at an encoder side and the input data correspond to a quantized transform coefficients of the current block at a decoder side;
determine a QP (Quantization Parameter) offset, wherein the QP offset is related to complexity of the transform coefficients of the current block;
determine a modified QP for the current block based on an original QP for the current block and the QP offset; and
apply a quantization process to the current block at the encoder side or apply an inverse quantization process to the current block at the decoder side by using the modified QP.

21. A method of video coding, the method comprising:
receiving input data related to a current block in a current picture, wherein the input data correspond to transform coefficients/residuals of the current block at an encoder side and the input data correspond to transform coefficients/residuals of the current block at a decoder side;
determining complexity of the transform coefficients/residuals of the current block;
determining context modelling or binarization of coefficient/residuals coding for the current block depending on the complexity of the transform coefficients/residuals of the current block; and
encoding or decoding the current block according to the context modelling or the binarization of coefficient/residual coding.

22. The method of claim 21, wherein the context modelling comprises target context modelling of significant coefficient flag or one or more syntaxes related to determining whether one or more coefficients are non-zero or not.

23. The method of claim 21, wherein the context modelling or the binarization of coefficient/residual coding comprises target context modelling or target binarization of last significant coefficient position.

24. The method of claim 21, wherein the context modelling or the binarization of coefficient/residual coding comprises target context modelling or target binarization of one or more coefficient levels.

25. The method of claim 21, wherein the context modelling or the binarization of coefficient/residual coding for a first block having high complexity of the transform coefficients/residuals of the first block is different from the context modelling or the binarization of coefficient/residual coding for a second block having low complexity of the transform coefficients/residuals of the second block.

26. An apparatus of video coding, the apparatus comprising one or more electronic circuits or processors arranged to:
receive input data related to a current block in a current picture, wherein the input data correspond to transform coefficients of the current block at an encoder side and the input data correspond to transform coefficients/residuals of the current block at a decoder side;
determine complexity of the transform coefficients/residuals of the current block;
determine context modelling or binarization of coefficient/residuals coding for the current block depending on the complexity of the transform coefficients/residuals of the current block; and
encode or decode the current block according to the context modelling or the binarization of coefficient/residual coding.
